(19) United States
(12) Patent Application Publication
(10) Pub. No.: US 2022/0275570 A1
(43) Pub. Date: Sep. 1, 2022

(54) FIBER TREATMENT AGENT, ARTIFICIAL-HAIR FIBER, AND HAIRPIECE PRODUCT

(71) Applicant: DENKA COMPANY LIMITED, Tokyo (JP)

(72) Inventors: Atsushi HORIHATA, Tokyo (JP); Masamichi KANAOKA, Tokyo (JP); Atsushi TAKEI, Tokyo (JP)

(73) Assignee: DENKA COMPANY LIMITED, Tokyo (JP)

(21) Appl. No.: 17/632,620

(22) PCT Filed: Jul. 16, 2020
(86) PCT No.: PCT/JP2020/027701

§ 371 Date: Feb. 3, 2022

(30) Foreign Application Priority Data
Sep. 26, 2019 (JP) 2019-175342

(51) Int. Cl. D06M 13/467; D06M 13/41; A41G 3/00

(52) U.S. Cl. CPC D06M 13/467; D06M 13/41; A41G 3/00; D06M 2101/12

(57) ABSTRACT

A fiber treatment agent can provide artificial hair fiber with softness. The fiber treatment agent includes a cationic polymer having a structural unit derived from diallyldimethylammonium chloride (DADMAC), and content of the cationic polymer is 0.02 to 0.5 weight %. The cationic polymer preferably has a structural unit derived from acrylamide. Preferably, the fiber treatment agent further includes an antistatic agent, and content of the antistatic agent is 0.2 to 5.0 weight %.

### TECHNICAL FIELD

The present invention relates to a fiber treatment agent of fibers used for headdress product such as wig, hair piece, braid, extension hair and the like (hereinafter referred to as “artificial hair fiber”), and to artificial hair fibers and headdress product using such.

### BACKGROUND

Conventionally, fiber treatment agent for making the texture of artificial hair fiber closer to that of the human hair has been known (for example, Patent Literature 1).

### CITATION LIST

### Patent Literature

[Patent Literature 1] JP 2011-184831A

### SUMMARY OF INVENTION

### Technical Problem

In recent years, fiber treatment agent for providing softness to artificial hair fiber is required.

### Solution to Problem

The present inventors have conducted intensive studies, and found that by using a fiber treatment agent comprising a cationic polymer having a structural unit derived from diallyldimethylammonium chloride (DADMAC), artificial hair fiber having softness can be obtained, thereby leading to completion of the present invention.

According to the present invention, a fiber treatment agent comprising a cationic polymer and an antistatic agent; wherein the cationic polymer has a structural unit derived from diallyldimethylammonium chloride (DADMAC), and content of the cationic polymer is 0.02 to 0.5 weight %, is provided.

Hereinafter, various embodiments of the present invention will be explained. The embodiments shown below can be combined with each other.

Preferably, the cationic polymer further has a structural unit derived from acrylamide.

Preferably, the fiber treatment agent further comprises an antistatic agent; wherein: content of the antistatic agent is 0.2 to 5.0 weight %.

According to another aspect of the present invention, an artificial hair fiber surface-treated with the fiber treatment agent is provided.

Preferably, regarding the artificial hair fiber, adhesion amount of the cationic polymer to the artificial hair fiber with respect to a weight of the artificial hair fiber is 0.005 to 0.1 weight %.

Preferably, regarding the artificial hair fiber, adhesion amount of the antistatic agent to the artificial hair fiber with respect to a weight of the artificial hair fiber is 0.005 to 0.1 weight %.

According to another aspect of the present invention, an artificial hair fiber, wherein: a cationic polymer is adhered on the artificial hair fiber; the cationic polymer has a structural unit derived from diallyldimethylammonium chloride; and adhesion amount of the cationic polymer with respect to a weight of the artificial hair fiber is 0.005 to 0.1 weight %, is provided.

Preferably, regarding the artificial hair fiber, an antistatic agent is further adhered on the artificial hair fiber; and adhesion amount of the antistatic agent is 0.005 to 0.1 weight %.

According to another aspect of the present invention, a headdress product comprising the artificial hair fiber, is provided.

### DESCRIPTION OF EMBODIMENTS

The fiber treatment agent of the present embodiment comprises a cationic polymer. By applying the fiber treatment agent on the surface of the artificial hair fiber, softness is provided to the artificial hair fiber.

The cationic polymer is a water-soluble polymer having a cationic group, and exhibits cationic property as a whole. In the present embodiment, the cationic polymer has a structural unit derived from diallyldimethylammonium chloride (DADMAC). Accordingly, the fiber treatment agent can provide sufficient softness to the artificial hair fiber.

The cationic polymer preferably has a structural unit derived from acrylamide. When the cationic polymer has the structural unit derived from acrylamide, tackiness of the artificial hair fiber treated with the fiber treatment agent can be suppressed.

Content of the cationic polymer in the fiber treatment agent is preferably 0.02 to 0.5 weight %, more preferably 0.05 to 0.3 weight %. When the content of the cationic polymer is 0.02 weight % or more, sufficient softness can be provided to the artificial hair fiber. When the content of the cationic polymer is 0.5 weight % or less, tackiness of the artificial hair fiber can be suppressed. The content of the cationic polymer is, particularly for example, 0.02, 0.03, 0.04, 0.05, 0.06, 0.07, 0.08, 0.09, 0.1, 0.2, 0.3, 0.4, or 0.5 weight %, and can be in the range between the two values exemplified herein.

The fiber treatment agent preferably comprises an antistatic agent. As the antistatic agent, anionic surfactant, cationic surfactant, amphoteric surfactant, nonionic surfactant, ionic liquid and the like can be mentioned. In terms of suppressing tackiness of the artificial hair fiber treated with the fiber treatment agent, the antistatic agent is preferably ionic liquid.

As the positive ion of the ionic liquid, ammonium ion, imidazolium ion, pyridinium ion, pyrrolidinium ion, pyrrolinium ion, piperidinium ion, pyrazinium ion, pyrimidinium ion, triazolium ion, triazinium ion, quinolinium ion, isoquinolinium ion, indolinium ion, quinoxalinium ion, piperazinium ion, oxazolinium ion, thiazolinium ion, morpholinium ion and the like can be mentioned. As the negative ion of the ionic liquid, halogen based ion, boron based ion, phosphorus based ion, sulfonic acid anion and the like can be mentioned.

Content of the antistatic agent is preferably 0.2 to 5.0 weight %, more preferably 0.5 to 2.0 weight %. When the content of the antistatic agent is 0.2 weight % or more, sufficient antistatic property can be provided to the artificial hair fiber. When the content of the antistatic agent is 5.0 weight % or less, tackiness of the artificial hair fiber can be suppressed. The content of the antistatic agent is, particularly for example, 0.2, 0.3, 0.4, 0.5, 0.6, 0.7, 0.8, 0.9, 1.0, 2.0, 3.0, 4.0, or 5.0 weight %, and can be in the range between the two values exemplified herein.

The fiber treatment agent can include antimicrobial processing agent, deodorant processing agent, antifungal processing agent, UV cutting agent, softening agent, SR processing agent, aromatic processing agent, flame retardant, defoaming agent, fragrance and the like.

The fiber treatment agent is applied on the surface of the artificial hair fiber. The artificial hair fiber after having the fiber treatment agent applied is used for headdress products such as wig, hair piece, braid, extension hair and the like. The headdress product according to one embodiment of the present invention includes artificial hair fiber having the fiber treatment agent applied thereon, and having effective component adhered thereon.

As the method for adhering the fiber treatment agent on the artificial hair fiber, conventional method for applying liquid on artificial hair fiber can be adopted. For example, a method in which the artificial hair fiber is wound onto a roll having the fiber treatment agent adhered on its surface, a method in which the artificial hair fiber is immersed in a liquid tank filled with the fiber treatment agent, a method in which the fiber treatment agent is adhered on the artificial hair fiber by a tool for coating such as brush, coating brush and the like, can be mentioned.

Regarding the fiber treatment agent, it is preferable that the effective component, that is, the compound contained in the treatment agent (cationic polymer and antistatic agent), adhere onto the surface of the artificial hair fiber by a specified ratio. The total amount of the cationic polymer and the antistatic agent adhered onto the artificial hair fiber with respect to the weight of the artificial hair fiber is preferably 0.01 to 0.2 weight %. When the adhesion amount of the effective component is less than 0.01 weight %, the effect of the fiber treatment agent cannot be expected, and there is a possibility that the effect for antistatic property and softness cannot be achieved. In addition, when the adhesion amount of the effective component exceeds 0.2 weight %, tackiness occur with the artificial hair fiber, and thus texture can degrade.

The adhesion amount of the cationic polymer to the artificial hair fiber is preferably 0.005 to 0.1 weight % with respect to the weight of the artificial hair fiber. When the adhesion amount of the cationic polymer is in such range, sufficient softness can be provided to the artificial hair fiber. When the adhesion amount of the cationic polymer is 0.1 weight % or less, the tackiness of the artificial hair fiber can be suppressed. The adhesion amount of the cationic polymer is, particularly for example, 0.005, 0.006, 0.007, 0.008, 0.009, 0.01, 0.02, 0.03, 0.04, 0.05, 0.06, 0.07, 0.08, 0.09, or 0.1 weight %, and can be in the range between the two values exemplified herein.

The adhesion amount of the antistatic agent to the artificial hair fiber with respect to the weight of the artificial hair fiber is preferably 0.005 to 0.1 weight %. When the adhesion amount of the antistatic agent is 0.005 weight % or more, sufficient antistatic property can be provided to the artificial hair fiber. When the adhesion amount of the antistatic agent is 0.1 weight % or less, tackiness of the artificial hair fiber can be suppressed. The adhesion amount of the antistatic agent is, particularly for example, 0.005, 0.006, 0.007, 0.008, 0.009, 0.01, 0.02, 0.03, 0.04, 0.05, 0.06, 0.07, 0.08, 0.09, or 0.1 weight %, and can be in the range between the two values exemplified herein.

As the artificial hair fiber, vinyl chloride based fiber, polyester based fiber, and polyamide based fiber can be mentioned. The artificial hair fiber is manufactured through melt spinning step, drawing step, and annealing step. In the melt spinning step, undrawn fiber is manufactured by melt spinning a resin composition. In particular, single screw extruder, twin screw extruder, roller, Banbury mixer, kneader and the like is used to melt and knead the vinyl chloride based resin, polyester based resin or polyamide based resin with various compounding agent such as heat stabilizer, lubricant, flame retardant, UV absorber and the like as necessary. Subsequently, melt spinning is carried out by normal melt spinning method. Here, the undrawn fiber is obtained by controlling the fineness and adjusting the winding speed.

In the drawing step, the undrawn fiber obtained is drawn by a drawing magnitude of 1.5 to 5.0 times, thereby manufacturing a drawn fiber. The drawing magnitude is preferably 2.0 to 4.0 times. When the drawing magnitude is sufficiently large, fiber strength tends to be achieved suitably, and when the drawing magnitude is sufficiently small, thread breakage during drawing processing tends to be suppressed.

The temperature during the drawing processing is preferably 80 to 120° C. When the temperature during the drawing processing is too low, the fiber strength tends to become weak and thread breakage tends to occur easily. When the temperature of the drawing processing is too high, the texture of the fiber obtained tends to be close to those of slippery plastic.

In the annealing step, the drawn fiber is subjected to heat treatment at a heat treatment temperature of 100 to 200° C. With this heat treatment, thermal shrinkage of the drawn fiber can be suppressed. The heat treatment can be performed following the drawing processing, or can be performed some time after the drawn fiber is wound.

The fineness of single fiber of the artificial hair fiber according to the present embodiment is preferably 20 to 100 decitex, more preferably 35 to 80 decitex. In order to achieve such fineness of single fiber, fineness of fiber immediately after the melt spinning step (undrawn fiber) is preferably adjusted to 300 decitex or lower. When the fineness of the undrawn fiber is small, the drawing magnitude for obtaining artificial hair fiber with low fineness can be made small, thereby suppressing occurrence of gloss in the artificial hair fiber after drawing processing.

The artificial hair fiber is preferably (1) artificial hair fiber formed from vinyl chloride based resin, or (2) artificial hair fiber formed from polyamide based resin. The vinyl chloride based resin is obtained by bulk polymerization, solution polymerization, suspension polymerization, emulsion polymerization and the like. Preferably, the vinyl chloride based resin is obtained by suspension polymerization in terms of initial colorability of the fiber and the like. The vinyl chloride based resin is a homopolymer resin which is a homopolymerized product of vinyl chloride or various copolymer resin, or a mixture of these. As the copolymer resin, copolymer resin of vinyl chloride and vinyl ester such as vinyl chloride-vinyl acetate copolymer resin and vinyl chloride-vinyl propionate copolymer resin; copolymer resin of vinyl chloride and acrylic ester such as vinyl chloride-butyl acrylate copolymer resin and vinyl chloride-2-ethylhexyl acrylate copolymer resin; copolymer resin of vinyl chloride and olefin such as vinyl chloride-ethylene copolymer resin and vinyl chloride-propylene copolymer resin; vinyl chloride-acrylonitrile copolymer resin and the like can be mentioned. Regarding the copolymer resin, the content of the comonomer can be decided depending on the required quality such as processability, fiber property and the like. The vinyl chloride based resin is preferably one of vinyl chloride resin, mixture of vinyl chloride resin and chlorinated vinyl chloride resin, vinyl chloride-acrylonitrile copolymer, or is a mixture of two or more of these.

As the polyamide based resin, nylon 6, nylon 66, nylon 11, nylon 12, nylon 6.10, nylon 6.12, and copolymer of these can be mentioned. Preferably, polyamide based resin is nylon 6, nylon 66, or copolymer of nylon 6 and nylon 66.

### EXAMPLES

Hereinafter, the present invention will be explained in detail with reference to Examples and Comparative Examples.

### 1. Formulation of Fiber Treatment Agent

Formulation of each of the Examples and Comparative Examples are shown in Table 1. The materials used for the fiber treatment agent are as follows. Here, when obtained as a commercially available product, cationic polymers A and B are in the form of an emulsion, and cationic polymer C and antistatic agent B are in the form of an aqueous solution. Accordingly, the blending amount of the cationic polymers A and B shown in Table 1 is the content of the cationic polymer in the emulsion, and the blending amount of the cationic polymer C and the antistatic agent B shown in Table 1 is the content of the cationic polymer or the antistatic agent in the aqueous solution.

cationic polymer A: (available from SENKA Corporation: COSMUAT V-39 (structured with structural unit derived from DADMAC, structural unit derived from acrylamide, and structural unit derived from acrylic acid))

cationic polymer B: (available from SENKA Corporation: COSMUAT VH (structured with structural unit derived from DADMAC and structural unit derived from acrylamide))

cationic polymer C: (available from SENKA Corporation: UNISENCE FPA100L (structured with structural unit derived from DADMAC))

antistatic agent A: ionic liquid (available from NIPPON NYUKAZAI CO., LTD.: Aminoion AS300)

antistatic agent B: quaternary ammonium salt based cationic activator (available from Kao Corporation: QUARTAMIN 60W)

TABLE 1

| | | Example1 | Example2 | Example3 | Example4 | Example5 | Example6 | Example7 |
|---|---|---|---|---|---|---|---|---|
| fiber treatment | water | 98.97 | 98.9 | 98.6 | 99.4 | 97.9 | 98.9 | 98.9 |
| agent | cationic polymer A | 0.03 | 0.1 | 0.4 | 0.1 | 0.1 | | 0.1 |
| | cationic polymer B | | | | | | 0.1 | |
| | cationic polymer C | | | | | | | |
| | antistatic agent A | 1 | 1 | 1 | 0.5 | 2 | 1 | 0 |
| | antistatic agent B | 0 | 0 | 0 | 0 | 0 | 0 | 1 |
| fiber | | vinyl | vinyl | vinyl | vinyl | vinyl | vinyl | vinyl |
| | | chloride | chloride | chloride | chloride | chloride | chloride | chloride |
| | | based | based | based | based | based | based | based |
| adhesion | cationic polymer | 0.0075 | 0.021 | 0.081 | 0.019 | 0.018 | 0.028 | 0.022 |
| amount of | antistatic agent | 0.021 | 0.024 | 0.022 | 0.013 | 0.048 | 0.026 | 0.032 |
| effective | | | | | | | | |
| component | | | | | | | | |
| (weight %) | | | | | | | | |
| evaluation | surface | 2.5 × 10⁹ | 5.2 × 10⁹ | 3.7 × 10⁹ | 1.2 × 10¹¹ | 4.1 × 10⁸ | 6.5 × 10⁹ | 2.8 × 10⁹ |
| | resistance (Ω) | | | | | | | |
| | tackiness | A | A | B | A | A | A | B |
| | softness | B | A | B | A | A | A | A |
| | | | | | | | Comparative | Comparative |
| | | Example8 | Example9 | Example10 | Example11 | Example12 | Example1 | Example2 |
| fiber treatment | water | 98.9 | 98.9 | 98.9 | 99.8 | 92.9 | 98.99 | 98 |
| agent | cationic polymer A | 0.1 | 0.1 | | 0.1 | 0.1 | 0.01 | 1 |
| | cationic polymer B | | | | | | | |
| | cationic polymer C | | | 0.1 | | | | |
| | antistatic agent A | 1 | 1 | 1 | 0.1 | 7 | 1 | 1 |
| | antistatic agent B | 0 | 0 | 0 | 0 | 0 | 0 | 0 |
| fiber | | polyester | polyamide | vinyl | vinyl | vinyl | vinyl chloride | vinyl chloride |
| | | based | based | chloride | chloride | chloride | based | based |
| | | | | based | based | based | | |
| adhesion | cationic polymer | 0.023 | 0.020 | 0.024 | 0.023 | 0.022 | 0.0032 | 0.19 |
| amount of | antistatic agent | 0.025 | 0.023 | 0.026 | 0.0031 | 0.14 | 0.025 | 0.021 |
| effective | | | | | | | | |
| component | | | | | | | | |
| (weight %) | | | | | | | | |
| evaluation | surface | | | | | | | |
| | resistance (Ω) | 5.5 × 10⁹ | 8.2 × 10⁹ | 2.4 × 10⁹ | 7.6 × 10¹³ | 1.4 × 10⁸ | 2.6 × 10⁹ | 6.6 × 10⁹ |
| | tackiness | A | A | B | A | C | A | C |
| | softness | A | A | A | A | A | C | C |

### 2. Artificial Hair Fiber

As the artificial hair fiber, vinyl chloride based fiber was used in Examples 1 to 10 and Comparative Examples 1 to 4. In Example 8, polyester based fiber was used, and in Example 9, polyamide based fiber was used. The following ones were used as each of the fibers. Average fineness of each of the fibers was 55 to 70 dtex.

vinyl chloride based fiber: prepared by Denka Company Limited (polyvinyl chloride (available from TAIYO VINYL CORPORATION, TH-700) was used)

polyester based fiber: prepared by Denka Company Limited (polyethylene terephthalate (available from Mitsui Chemicals, Inc., J125S) was used)

polyamide based fiber: prepared by Denka Company Limited (polyamide 66 (available from Toray Industries, Inc., AMILAN CM3001-N) was used)

### 3. Application of Fiber Treatment Agent

With each of the Examples and Comparative Examples, after drawing was completed in the manufacturing process of the fiber, the fiber treatment agent was applied on the artificial hair fiber by roller transfer method. Subsequently, the fiber treatment agent was dried in the annealing step of the fiber. The adhesion amount (weight %) of the effective component (cationic polymer and antistatic agent) of the fiber treatment agent adhered on the artificial hair fiber with respect to the weight of the artificial hair fiber is shown in Table 1.

### 4. Evaluation of Artificial Hair Fiber

### (1) Antistatic Property (Surface Resistance)

With each of the Examples and Comparative Examples, the artificial hair fiber was bundled to have 250 mm length and 20 g weight. The bundled fiber was allowed to stand under conditions of 23° C. and 50% RH for 24 hours, and then surface resistance was measured using a digital ultra high resistance/micro current meter (available from ADVANTEST CORPORATION, R8340) under applied voltage of 10 V. Then, average of the measured values was obtained by N=5. Here, the lower the surface resistance of the artificial hair fiber, the antistatic property becomes superior.

### (2) Tackiness

Tackiness was evaluated as follows. The artificial hair fiber of the Examples and Comparative Examples were bundled to have 250 mm length and 20 g weight. The bundles were evaluated by 10 artificial hair fiber engineers (5 or more years of experience) by hand touch observation in accordance with the following criteria.

A: ratio of engineers who evaluated there was no tackiness and texture was superior was 90% or more

B: ratio of engineers who evaluated there was no tackiness and texture was superior was 70% or more and less than 90%

C: ratio of engineers who evaluated there was no tackiness and texture was superior was less than 70%

### (3) Softness

Softness was evaluated as follows. The artificial hair fiber of the Examples and Comparative Examples were bundled to have 250 mm length and 20 g weight. The bundles were evaluated by 10 artificial hair fiber engineers (5 or more years of experience) by hand touch observation in accordance with the following criteria.

A: ratio of engineers who evaluated there was softness was 90% or more

B: ratio of engineers who evaluated there was softness was 70% or more and less than 90%

C: ratio of engineers who evaluated there was softness was less than 70%

From the results of Examples 1 to 12 and Comparative Examples and 2, it can be understood that when the content of the cationic polymer in the fiber treatment agent is 0.02 weight % or more and 0.5 weight % or less, sufficient softness can be provided to the artificial hair fiber. In addition, it can be understood that when the content of the cationic polymer is 0.5 weight % or less, tackiness of the artificial hair fiber can be suppressed.

From the results of Examples 1 to 12 and Comparative Examples 1 and 2, it can be understood that when the adhesion amount of the cationic polymer to the artificial hair fiber is 0.005 weight % or more and 0.1 weight % or less, softness of the artificial hair fiber becomes superior. In addition, it can be understood that when the adhesion amount of the cationic polymer is 0.1 weight % or less, tackiness of the artificial hair fiber can be suppressed.

From the results of Examples 1 to 12, it can be understood that when the content of the antistatic agent in the fiber treatment agent is 0.2 weight % or more, sufficient antistatic property can be provided to the artificial hair fiber. In addition, it can be understood that when the content of the antistatic agent is 5.0 weight % or less, tackiness of the artificial hair fiber can be suppressed.

From the results of Examples 1 to 12, it can be understood that when the adhesion amount of the antistatic agent to the artificial hair fiber is 0.005 weight % or more, antistatic property of the artificial hair fiber becomes superior. In addition, it can be understood that when the adhesion amount of the antistatic agent to the artificial hair fiber is 0.1 weight % or less, tackiness of the artificial hair fiber can be suppressed.

From the results of Examples 1 to 10, it can be understood that when the cationic polymer A or B having structural unit derived from acrylamide is used as the cationic polymer, tackiness of the artificial hair fiber tends to be suppressed.

1. A fiber treatment agent, comprising:
a cationic polymer having a structural unit derived from diallyldimethylammonium chloride; wherein:
content of the cationic polymer is 0.02 to 0.5 weight %.

2. The fiber treatment agent of claim 1, wherein the cationic polymer further has a structural unit derived from acrylamide.

3. The fiber treatment agent of claim 1, further comprising an antistatic agent; wherein:
content of the antistatic agent is 0.2 to 5.0 weight %.

4. An artificial hair fiber surface-treated with the fiber treatment agent of any one of claim 1.

5. The artificial hair fiber of claim 4, wherein adhesion amount of the cationic polymer to the artificial hair fiber with respect to a weight of the artificial hair fiber is 0.005 to 0.1 weight %.

6. The artificial hair fiber of claim 4, wherein:
the fiber treatment agent further comprises an antistatic agent;
content of the antistatic agent is 0.2 to 5.0 weight %; and
adhesion amount of the antistatic agent to the artificial hair fiber with respect to a weight of the artificial hair fiber is 0.005 to 0.1 weight %.

7. An artificial hair fiber, wherein:
a cationic polymer is adhered on the artificial hair fiber;
the cationic polymer has a structural unit derived from diallyldimethylammonium chloride; and
adhesion amount of the cationic polymer with respect to a weight of the artificial hair fiber is 0.005 to 0.1 weight %.

8. The artificial hair fiber of claim 7, wherein:
an antistatic agent is further adhered on the artificial hair fiber; and
adhesion amount of the antistatic agent is 0.005 to 0.1 weight %.

9. A headdress product comprising the artificial hair fiber of claim 4.
